(19) United States
(12) Patent Application Publication
(10) Pub. No.: US 2011/0242316 A1
(43) Pub. Date: Oct. 6, 2011

(54) SHOE-INTEGRATED TACTILE DISPLAY FOR DIRECTIONAL NAVIGATION

(76) Inventor: Ramiro Velazquez Guerrero, Aguasralientes (MX)

(21) Appl. No.: 12/889,118

(22) Filed: Sep. 23, 2010

Related U.S. Application Data
(60) Provisional application No. 61/319,074, filed on Mar. 30, 2010.
(60) Provisional application No. 61/364,279, filed on Jul. 14, 2010.

(51) Int. Cl. G08B 6/00; G06K 9/00; H04N 7/18

(52) U.S. Cl. 348/143; 340/407.1; 382/103; 348/E07.085

(57) ABSTRACT

Described herein are embodiments of a shoe-integrated tactile display that enables users to obtain information through the sense of touch of their feet. Also provided are methods and systems for directional navigation via a shoe integrated tactile display. Additionally provided are methods and systems for calibrating one or more actuators to a user's preference to enhance the transmission of tactile information. Provided as well are systems and methods for image processing so that a collision free path can be determined.

### CROSS REFERENCE TO RELATED APPLICATION

This application claims benefit of and priority to U.S. Provisional Patent Applications Ser. Nos. 61/319,074 and 61/364,279 filed Mar. 30, 2010 and Jul. 14, 2010, respectively, which are each fully incorporated herein by reference and made a part hereof.

### BACKGROUND

Human interaction with space is based on cognitive representations built upon somatosensory data. The majority of somatosensory information transmitted through the nerves into the brain is critical for key human functions such as motion, posture and sensing. Somatosensory input from the lower limb, particularly from the foot sole, has long been recognized as an important source of sensory information in controlling movement and standing balance. However, the capabilities of the foot for information transmission have not been fully exploited.

The human foot combines mechanical complexity and structural strength. The ankle serves as foundation, shock absorber and propulsion engine. The foot can sustain enormous pressure and provides flexibility and resiliency. Additionally, the cutaneous receptors of the foot sole continuously provide feedback information to assist in balance and walking. Skin receptors in the foot sole are sensitive to contact pressures and to changes in the distribution of pressure. As the load on the foot is transferred from heel to toe, pressure signals are automatically fed back to the brain to provide important information about the body's position with respect to the supporting surface.

Researchers have illustrated the importance of cutaneous receptors in the control of posture and standing balance, however, their work has not focused on evaluating the performance of the foot sole receptors for information transmission. Further, there are many potential applications that would benefit from utilizing foot sole receptors for information transmission. Some examples include virtual reality, robotics, rehabilitation, games and entertainment, among many others.

Another potential area of application for this technology is the assistance of the blind or visually impaired. Over the last four decades, a large number of electronic travel aids (ETAs) have been proposed to improve mobility and safety navigation independence of the blind. However, none of these devices are widely used and user acceptance is quite low due to several shortcomings that have been identified in existing ETAs. One of the most prevalent reasons for the low acceptance rate is that existing ETAs are still too burdensome and visually noticeable to be portable devices. This problem heightens the user's handicapped image and affects the user's self-esteem.

Any enhanced, unified solution that is more portable, less burdensome, and less conspicuous would be useful. Therefore, what is needed are systems and methods that overcome challenges found in the art, some of which are described above.

### SUMMARY

Described herein are embodiments of systems, methods and computer-program products for a shoe-integrated tactile display for directional navigation.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an exemplary diagram of a system for directional navigation by a shoe integrated tactile display;

FIG. 2 is an exemplary diagram of a system for information transmission by a shoe integrated tactile display;

FIG. 3 is a block diagram illustrating an exemplary operating environment for performing the disclosed methods;

FIG. 4 is a flow diagram of a method for using a user's input for tactile actuator calibration;

FIG. 5 is a flow diagram of a method for using tactile information for directional navigation;

FIGS. 6a-6c are examples of shoe insoles that have been modified to accommodate an electronic module and one or more actuators;

FIGS. 7a and 7b are exemplary models of actuators attached to shoe insoles, with the insoles inserted into shoes;

FIGS. 8a-8d show an exemplary method of activating actuators sequentially to transfer instructions to the user;

FIGS. 9a-9f show an exemplary method of activating actuators to transfer instructions to the user;

FIG. 10a is an exemplary view from an image capture device that has been processed by image tracking software;

FIG. 10b is an exemplary view of an image that has been converted with image tracking software so that a collision free path can be determined for the user;

FIG. 10c is an exemplary view of the steps taken by a user following the shoe integrated tactile display's instructions; and

FIG. 11 is a photograph of a user and an embodiment of a system for directional navigation by a shoe integrated tactile display.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

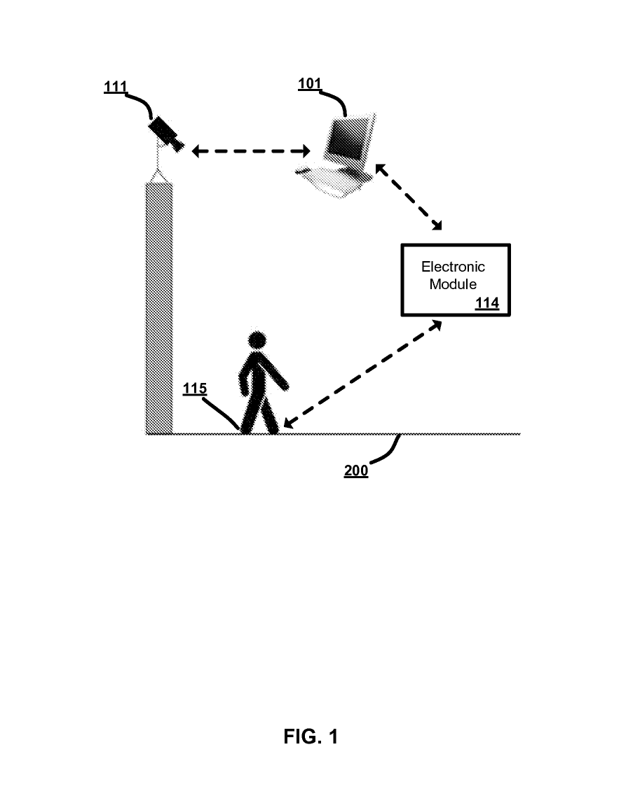

An exemplary system for directional navigation by a shoe integrated tactile display is illustrated in FIG. 1. An image capture device 111 is placed above a surface 200 and a user. The image capture device captures an image and transfers it to a computer 101 containing tactile software (not shown). The computer, using the tactile software, processes the captured image, identifies the user's location, identifies a collision free path, determines which direction the user should go to follow the collision free path and transmits the direction to an electronic module 114. The electronic module 114 receives and interprets the directions and transmits instructions to one or more actuators 115. The user feels the one or more actuators 115 activate and moves in the direction that is sensed by the user's tactile senses. This process can be repeated as often and as many times as needed to allow the user to successfully navigate a collision free path.

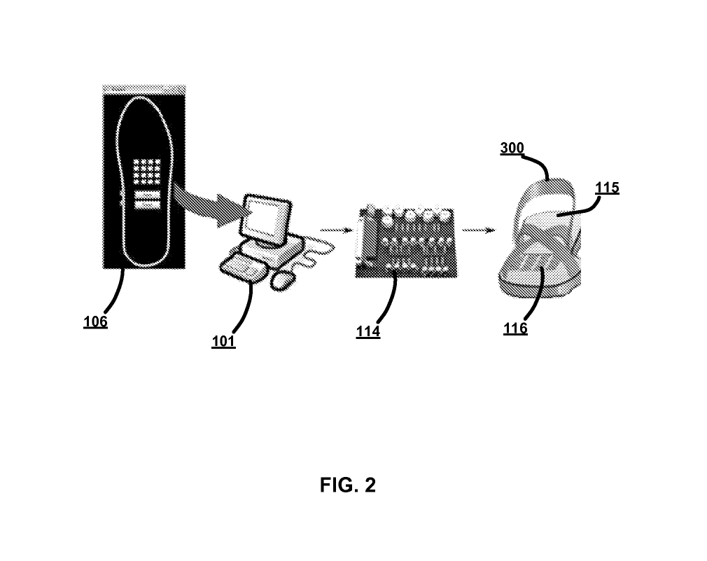

An exemplary system for information transmission by a shoe integrated tactile display is illustrated in FIG. 2. A computer 101 contains tactile software 106 that is configured to allow information to be transmitted to a user. The information is transmitted to an electronic module 114 that receives and interprets instructions and transmits the instructions to one or more actuators 116. The actuators 116 are attached to a shoe insole 115 that has been inserted into a user's shoe 300. The actuators 116 receive the instructions from the electronic module 114 and activate and deactivate accordingly.

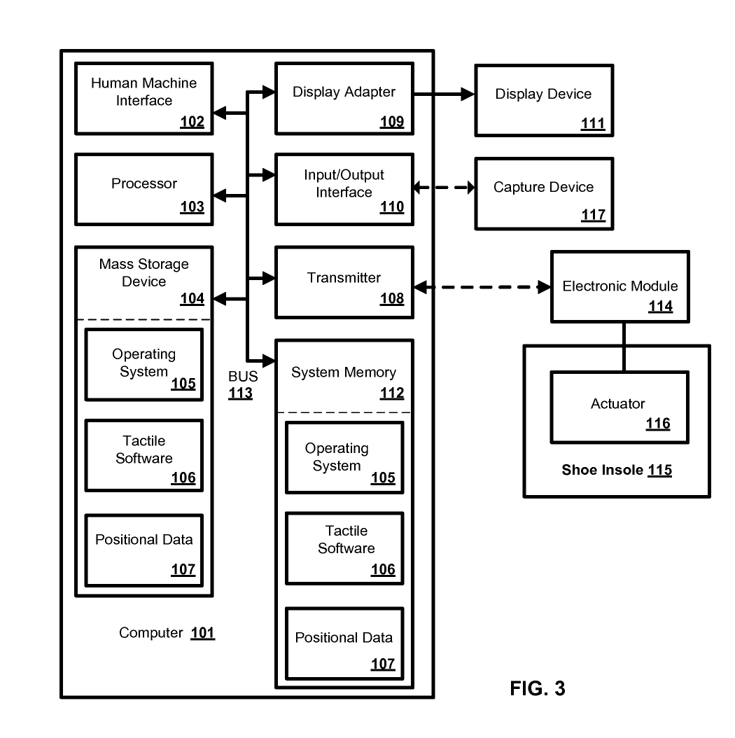

The system embodiments described herein are comprised of units. One skilled in the art will appreciate that this is a functional description and that the respective functions can be performed by software, hardware, or a combination of software and hardware. A unit can be software, hardware, or a combination of software and hardware. The units can comprise the tactile software 106 as illustrated in FIG. 3 and described below. In one exemplary aspect, the units can comprise a computer 101 as illustrated in FIG. 3 and described below.

FIG. 3 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, gaming systems and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, tactile software 106, positional data 107, a transmitter 108, system memory 112, an Input/Output Interface 110, a display adapter 109, a display device 111, and a human machine interface 102, can be contained within one or more remote electronic modules 114 at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as positional data 107 and/or program modules such as operating system 105 and tactile software 106 that are immediately accessible to and/or are presently operated on by the processing unit 103.

In another aspect, the computer 101 can also comprise other removable/non-removable, volatile/non-volatile computer storage media. By way of example, FIG. 1 illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and tactile software 106. Each of the operating system 105 and tactile software 106 (or some combination thereof) can comprise elements of the programming and the tactile software 106. Positional data 107 can also be stored on the mass storage device 104. Positional data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 101 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the computer 101 via Input/Output Interface 110. Any step and/or result of the methods can be output in any form to an output device. Such output can be any form of visual representation, including, but not limited to, textual, graphical, animation, audio, tactile, and the like.

In yet another aspect, a capture device 117 can also be connected to the system bus 113 via an interface, such as an input/output interface 110. It is contemplated that the computer 101 can have more than one input/output interface 110 and the computer 101 can have more than one capture device 117. Capture device 117 can be any of one or more known types of devices capable of capturing data. For example, a capture device can be a single lens reflex camera, a digital single lens reflex camera, a digital video recorder, a cellular phone, a camcorder, etc.

The computer 101 can operate in a networked environment using logical connections to one or more electronic modules 114. By way of example, an electronic module can be any device configured to receive a signal and convert it to a tactile representation using an actuator 116. Logical connections between the computer 101 and an electronic module 114 can be made via a local area network (LAN) and a general wide area network (WAN) and can be either wired or wireless. Such network connections can be through a transmitter 108. A transmitter 108 can be implemented in both wired and wireless environments.

In one aspect, an electronic module 114 can contain an electronic drive, capable of receiving a signal from transmitter 108. It is contemplated that the electronic module 114 can be connected to one or more actuators 116, with said actuators capable of receiving information from said electronic module. The one or more actuators 116 may be inserted or attached to a shoe insole 115. Further, the one or more actuators 116 can provide tactile information to a wearer/user.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of tactile software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Among the software elements included in computer system 101 is a tactile software package 106 that, in conjunction with the hardware and other elements of computer system 101, described above, affects the methods of the present invention. A tactile software package 106 is illustrated conceptually for purposes of illustration as residing in system memory 112, but as persons skilled in the art can appreciate, may not actually be stored or otherwise reside in memory in its entirety at any given time. Rather, portions or elements of it may be retrieved and executed or referenced on an as-needed basis in accordance with conventional operating system processes. It should be noted that tactile software package 106, as stored in or otherwise carried on any computer-usable data storage or transmission medium, can constitute a “computer program product” within the meaning of that term as used in the context of patent claims.

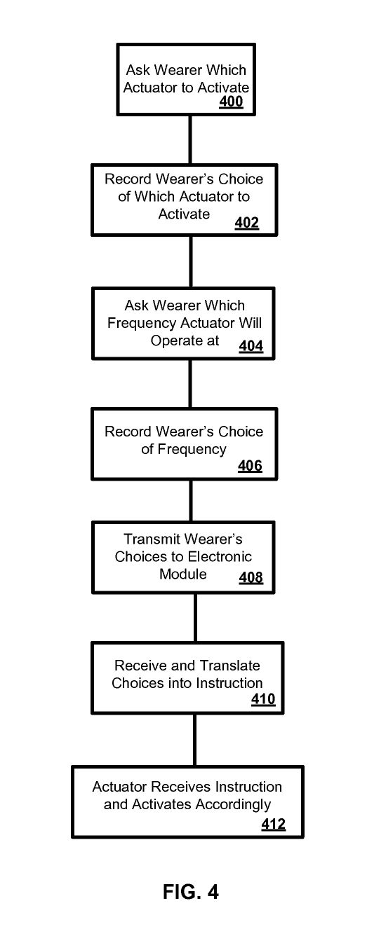

As illustrated in further detail in FIG. 4, one embodiment of the tactile software package 106 includes a number of steps that operate together to form a method for using a user's input to calibrate one or more tactile actuators 116. For example, a person wearing a shoe insole 115 with one or more actuators 116, is asked a series of questions to determine the user's preferences. In step 400, the user is asked which actuator or actuators to activate. In step 402, the user's choice of which of the one or more actuators to be activated is recorded. In step 404, the user is asked which frequency he/she prefers the one or more actuators to operate at. In step 406, the user's choice of which frequency the one or more actuators operate at is recorded. In step 408, the user's choices are transmitted by a transmitter 108 to an electronic module 114. In step 410, the electronic module 114 receives and translates the user's choices into instructions, which are then passed to one or more actuators 116. In step 412, the one or more actuators 116 receive the instructions and activate accordingly.

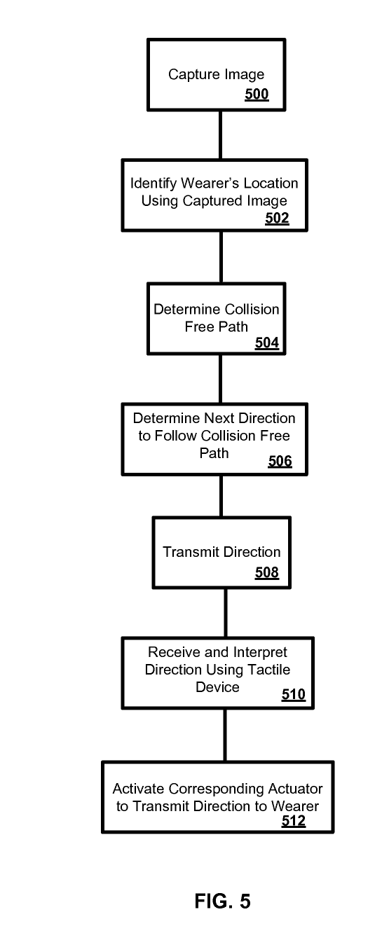

FIG. 5 shows an embodiment for a method of using tactile information for directional navigation. In step 500, a capture device 117 captures one or more images that will be used to identify the user, his/her surroundings, and a collision free path through the surroundings. In step 502, the captured image is used by tactile software 106 to determine the user's location within the captured image. In step 504, tactile software 106 uses the one or more captured images and the user's location to determine a collision free path. In step 506, tactile software 106 determines the next direction the user should follow to traverse the collision free path. In step 508, the direction is transmitted by transmitter 108 to an electronic module 114. In step 510, the electronic module 114 receives and interprets the direction. In step 512, the electronic module 114 activates one or more corresponding actuators 116 to transmit the direction to the user through tactile vibration.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

In another embodiment, the one or more actuators 116 can be affixed to a mat (not shown). In one aspect, the mat can be a flexible mat formed from rubber, plastic polymers, and any other materials known in the art. The one or more actuators can be evenly spaced throughout the mat, unevenly concentrated throughout the mat, or in any combination thereof. The mat can be coupled, wirelessly or wired, to an electric module 114 which can be capable of receiving instructions from a transmitter 108. The transmitter can be coupled, wirelessly or wired, to a computer 101 or a gaming device (not shown) such as NINTENDO WII, MICROSOFT XBOX, SONY PLAYSTATION, and any other gaming devices known in the art. The gaming device can send information to the user by transmitting instructions to the electric module 114. If a user is playing a game on the gaming device connected to the mat, the mat could receive information about the gaming environment. For example, if the user controls a character in a game, and the character strays from the correct path, the gaming system can relay this information to the user by transmitting instructions to the electronic module 114, which can then activate the corresponding one or more actuators 116 in the mat in order to alert the user to this information.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the scope of the methods and systems. Efforts have been made to ensure accuracy with respect to numbers (e.g., amounts, temperature, etc.), but some errors and deviations should be accounted for.

In various aspects, described embodiments or components of described embodiments can be used for or incorporated into systems and methods such as gaming platforms, simulators, motion analysis or gait analysis systems, modeling and rendering systems, three-dimensional modeling systems, etc.

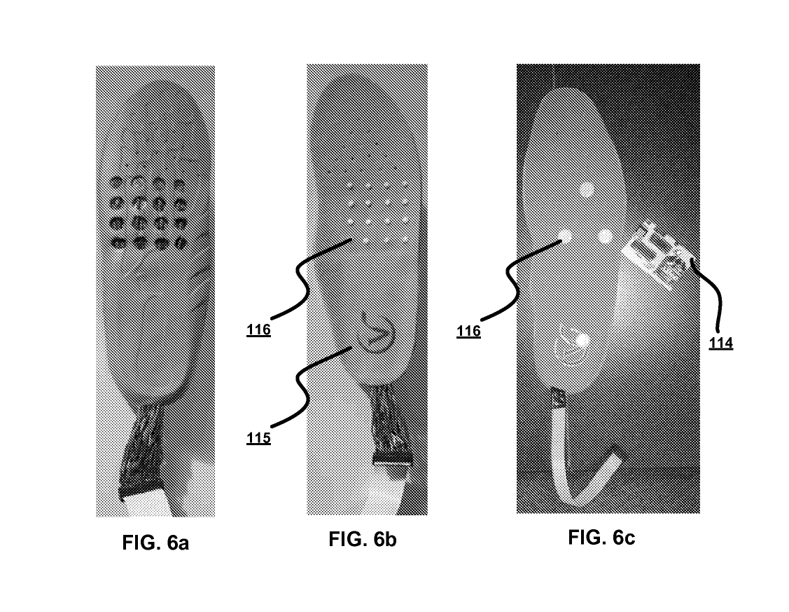

FIGS. 6-11 illustrate various aspects of embodiments of the present invention. An exemplary embodiment of shoe insoles that have been modified to accommodate an electronic module and one or more actuators is provided in FIGS. 6a-6c. Each of these figures show a shoe insole 115 that has been modified to allow one or more actuators 116 to provide a user with tactile information. FIG. 6a provides a bottom view of a shoe insole before the actuators have been attached. FIG. 6b provides a top view of a shoe insole 115 that has been modified to be coupled with one or more actuators 116 which have been attached so that the user's foot comes in contact with the actuators. FIG. 6c provides a wireless embodiment of a shoe insole with one or more actuators 116 and a wireless electronic module 114. One example of an actuator is a miniature vibrating DC electric motor that is 10 mm in diameter, 3 mm thick, weighs 12 g, is capable of vibrating within a range of 10-55 Hz, and is capable of exerting 13 mN of force. When this actuator receives an electrical signal it activates and deactivates when the signal is removed. This activation and deactivation stimulates the person's sense of touch and therefore, is capable of transmitting information to the person. An additional example of an acceptable actuator is model number C1030L-50, available from Jinlong Machinery in Zhejiang, China. These examples of actuators are merely embodiments of acceptable actuators but one skilled in the art will realize that any actuator capable of providing tactile information to a person will suffice.

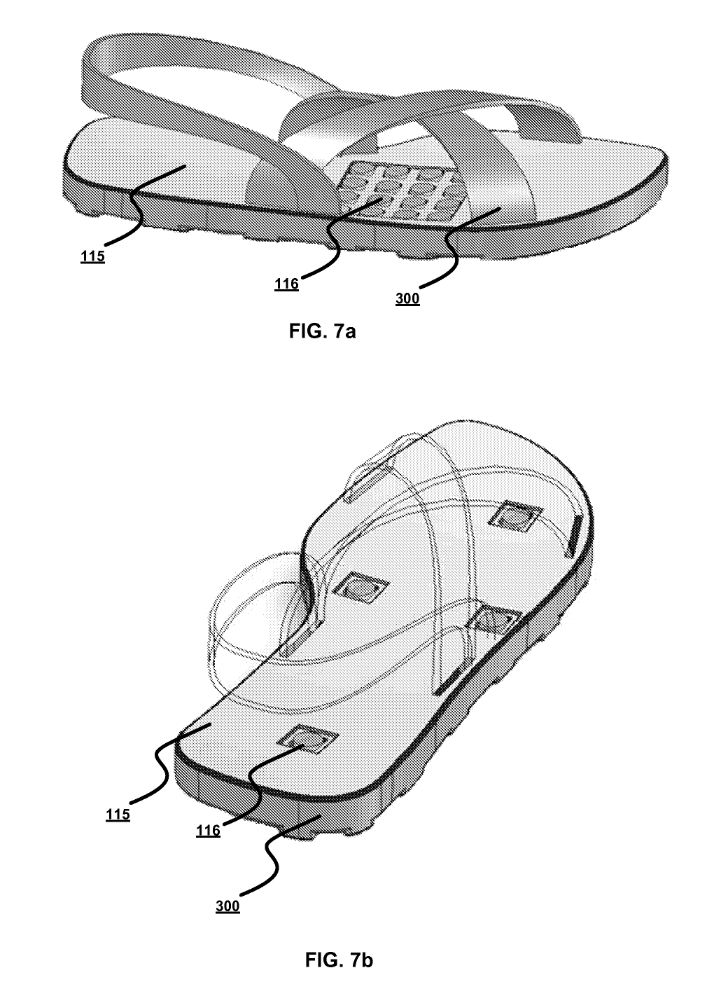

FIGS. 7a and 7b provides exemplary embodiments of a tactile device that has been inserted into a shoe. FIG. 7a provides a shoe insole 115 that has been modified to accommodate one or more actuators 116 to form a device capable of transmitting tactile information to a user. The tactile device is then inserted into a user's shoe 300 so that information can be transmitted to the user. FIG. 7b provides a tactile device with a lower number actuators 116 that are spread out over the length and width of the shoe insole 115 and inserted into the shoe 300.

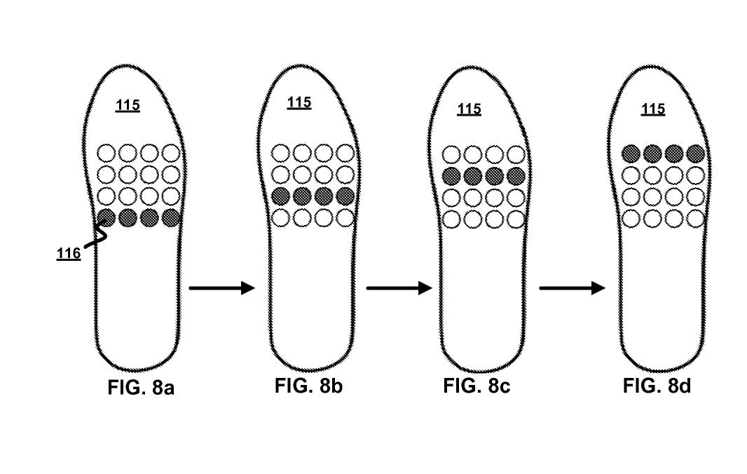

FIGS. 8a-8c illustrate an example of transmitting directional information to a user who is being directed North through the use of tactile information. In FIG. 8a the lowest row of actuators 116 is activated and deactivated, followed by the activation and deactivation of the next highest row of actuators in FIG. 8b, followed by the activation and deactivation of the next highest row of actuators in FIG. 8c, and finally the highest row of actuators are activated and deactivated in FIG. 8d. A person using this insole and experiencing this series of vibrations would be able to interpret this information as an instruction to travel North.

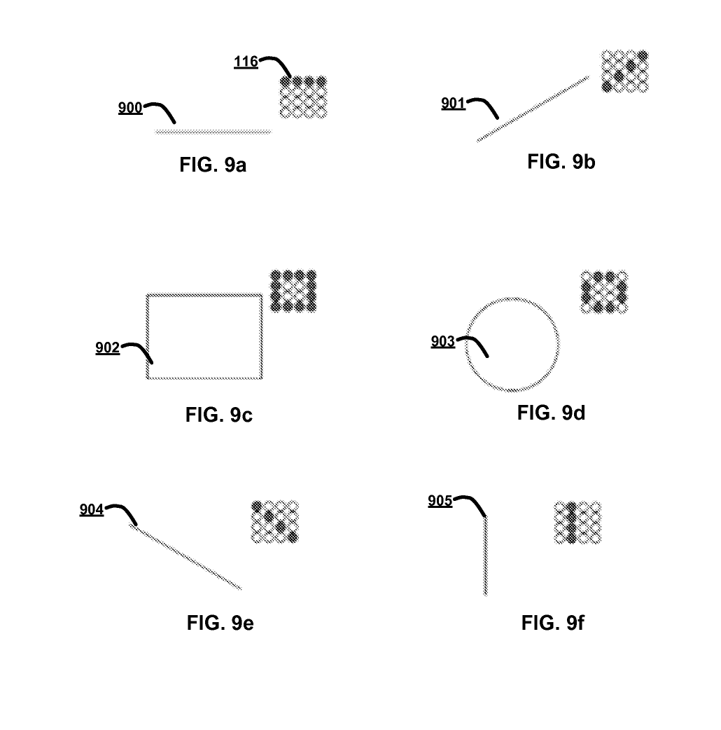

FIGS. 9a-9f illustrate examples of using tactile information to transmit shapes to a user through the use of actuators 116. In FIG. 9a the highest row of actuators are activated and deactivated to represent a straight horizontal line 900. In FIG. 9b, the actuators are activated and deactivated to represent a diagonal line 901. In FIG. 9c, the outside ring of actuators are activated and deactivated to represent a square 902. In FIG. 9d, the outside ring of actuators, except each corner, are activated and deactivated to represent a circle 903. In FIG. 9e, the actuators are activated and deactivated to represent a diagonal line 904. In FIG. 9f, the second column of actuators are activated and deactivated to represent a straight vertical line 905. One embodiment of a tactile device uses these types of signals to transmit different messages to a user. For example, a straight vertical line 905 can be repeated to the user several times very quickly to convey a “caution” signal. Additionally, the actuators could be triggered as in FIG. 9d to convey a “stop” signal to the user. Further, any number of actuators can be activated and deactivated in certain patterns to transmit information to the user. For example, two consecutive short vibrations, then a pause, then two consecutive short vibrations can represent a SMS message. Further, a long vibration, then a pause, then a long vibration can represent a ringing telephone. These examples of information transmission are merely a few methods of transmitting tactile information but one skilled in the art will realize that any method of providing tactile information to a person will suffice.

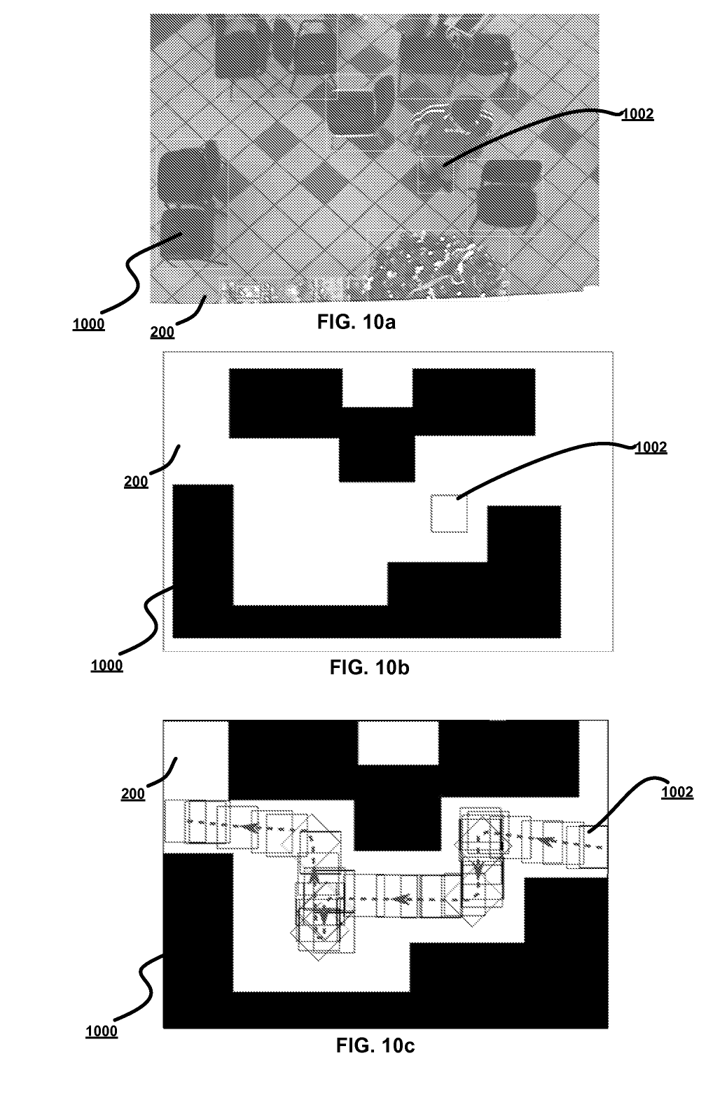

FIGS. 10a-10c provide exemplary images of images taken by an image capture device (not shown) to be used for directional navigation by a shoe integrated tactile display. FIG. 10a shows a user standing on a surface 200 who wishes to traverse a collision free path. The image has been processed by tactile software which has identified the user's feet 1002 and potential obstacles 1000. FIG. 10b shows the same image after it has been stripped of any unnecessary elements. The user has been reduced to a square representation 1002 by tracking his or her feet. The obstacles 1000 have been reduced so that a collision free path can be determined over the surface 200. FIG. 10c shows a user's path over the surface using directional navigation by a shoe integrated tactile display. The user's feet are tracked using a square for graphical representation 1002 and the tactile software determines which direction the user should step next. This process is carried out as often and as many times as necessary so that the user traverses the collision free path.

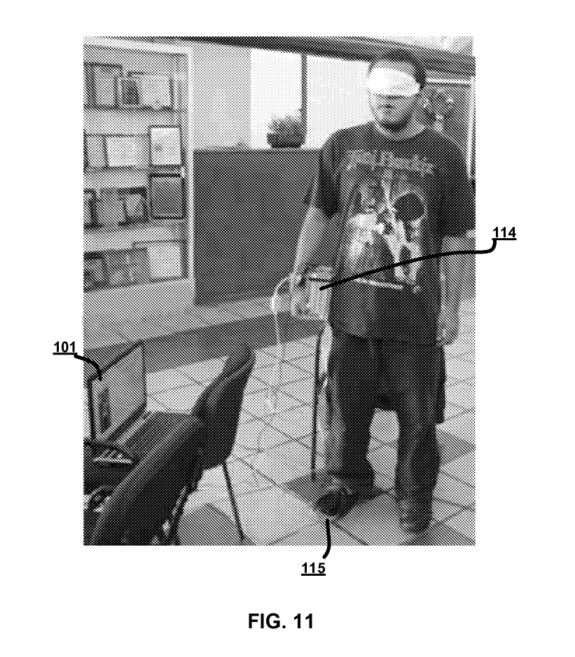

FIG. 11 provides an exemplary embodiment of a tactile device that has been inserted into a shoe and is connected to other components to create a system for information transmission by a shoe integrated tactile display. A computer 101 contains tactile software (not shown) that processes information and transmits the information to an electronic module 114. The electronic module 114 receives and interprets the information and transmits the information to one or more actuators (not shown) that have been fitted into the user's shoe insole 115. The one or more actuators (not shown) activate and deactivate accordingly to transmit the information to the user.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications may be referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims or inventive concepts.

What is claimed is:

1. A system comprising:
a computer, said computer comprising a processor, a memory and a transmitter, wherein the memory stores a tactile software application executable by the processor to produce instructions that are transmitted by said transmitter;
a shoe insole;
one or more actuators, coupled to the shoe insole, wherein the one or more actuators activate upon instruction; and
an electronic module, operably connected to said one or more actuators, wherein said electronic module receives and interprets said instructions from said transmitter, and is adapted to transmit instructions to said one or more actuators.

2. The system of claim 1, wherein the one or more actuators provide tactile information to a user of the shoe insole.

3. The system of claim 1, wherein the transmitter is a wireless transmitter, wherein the memory stores a tactile software application executable by the processor that produces instructions that are wirelessly transmitted by said transmitter.

4. The system of claim 3, wherein said electronic module wirelessly receives and interprets said instructions from said transmitter, and is adapted to transmit instructions to said one or more actuators.

5. The system of claim 1, wherein said electronic module is powered by a portable power supply.

6. The system of claim 2, wherein the tactile software is configured to activate a chosen actuator from said one or more actuators at a frequency chosen by the user.

7. The system of claim 1, wherein the instructions are transmitted using RS232 protocol.

8. The system of claim 1, further comprising an image capture device operably connected with the computer, wherein the image capture device is configured to capture one or more pictures to be used by the tactile software application to produce the instructions.

9. The system of claim 1, wherein the one or more actuators are configured to operate at one or more frequencies.

10. A method for directional navigation by tactile information, the method comprising:
a. capturing one or more images;
b. identifying, using a computer, a user's location, using the one or more images;
c. determining, using the computer, a collision free path using the one or more images;
d. determining, using the computer, a next direction to follow through said path;
e. transmitting, using the computer, said direction;
f. receiving and interpreting said direction using a tactile device; and
g. transmitting said direction to the user by activating one or more corresponding actuators in said tactile device.

11. The method of claim 10, further comprising repeating steps a. through g. until user has traversed said collision free path.

12. The method of claim 11, repeated every 0.5 seconds until user has traversed said collision free path.

13. The method of claim 10, wherein the tactile device comprises a shoe insole coupled to one or more actuators, wherein the one or more actuators activate upon instruction from an electronic module, wherein said electronic module receives and interprets instructions from a transmitter.

14. A method for tactile actuator calibration from user input, the method comprising:
a. asking for a user's choice of actuators to activate wherein said actuators comprise a tactile device worn on the foot;
b. recording the user's choice of actuators to activate;
c. asking for the user's choice of frequencies chosen actuators will operate at;
d. recording the user's choice of frequencies chosen actuators will operate at;
e. transmitting the user's choices to an electronic module, wherein said electronic module receives and translates said choices into instructions, and transmits said instructions; and
f. activating the chosen actuators according to the instructions received from said electronic module.

15. A system for directional navigation comprising:
an image capture device configured to capture one or more images;
a computer operably connected to said image capture device, said computer comprising a transmitter, a memory, wherein said memory contains computer-executable code, and a processor operably connected to said memory, wherein said processor is configured to execute said computer-executable code to perform the steps of:
processing said captured one or more images;
identifying a user's location, using the one or more images;
determining a collision free path, using the one or more images;
determining a next direction to follow said path; and
transmitting said direction, using said transmitter;
a shoe insole coupled to one or more actuators, wherein said actuators activate upon instruction; and
an electronic module, operably connected to said one or more actuators, wherein said electronic module receives and interprets said direction from said transmitter, and transmits instructions to said one or more actuators.

16. The system of claim 15, wherein said image capture device is positioned above the ground facing downward.

17. The system of claim 16, wherein said image capture device is positioned 25° from vertical and 4.0 meters above the recorded surface.

18. The system of claim 15, wherein the one or more actuators provide tactile information to a user of the shoe insole.

19. The system of claim 15, wherein the transmitter is a wireless transmitter, wherein the memory stores a tactile software application executable by the processor that produces instructions that are wirelessly transmitted by said transmitter.

20. The system of claim 19, wherein said electronic module wirelessly receives and interprets said instructions from said transmitter, and is adapted to transmit instructions to said one or more actuators.

21. The system of claim 15, wherein said electronic module is powered by a portable power supply.

22. The system of claim 15, wherein the computer-executable code is configured to activate a chosen actuator from said one or more actuators at a frequency chosen by the user.

23. The system of claim 15, wherein the instructions are transmitted using RS232 protocol.

24. A computer program product for directional navigation, said computer program product comprising one or more computer-executable code segments, said code segments comprising instructions for implementing the steps of:
processing one or more images from an image capture device;
identifying, a user's location, using the one or more images;
determining, a collision free path, using the one or more images;
determining, a next direction to follow through said path; and
transmitting, said direction to a tactile device, wherein said tactile device is configured to receive and interpret said direction from said transmitter, and is configured to convey said direction to the user by activating one or more actuators coupled to the user's shoe insole
